(19) United States
(12) Patent Application Publication
(10) Pub. No.: US 2015/0149062 A1
(43) Pub. Date: May 28, 2015

(54) INJECTOR CONTROL

(71) Applicant: International Engine Intellectual Property Company , LLC, Lisle, IL (US)

(72) Inventors: Louis Maza, Berwyn, IL (US); Michael Fritsch, Bartlett, IL (US); Artur Alojzy Dudzik, Plainfield, IL (US)

(21) Appl. No.: 14/089,826

(22) Filed: Nov. 26, 2013

(51) Int. Cl. F02D 41/30

(52) U.S. Cl. CPC F02D 41/3005
USPC 701/103

(57) ABSTRACT

A method for controlling the operation of a valve of a fuel injector. The method may include selecting an electrical current waveform from a plurality of selectable electrical current waveforms. The selected electrical current waveform is provided to the valve, which may be operated to control a characteristic of an injection event, such as, for example, fuel pressure, injection timing, and/or fuel mass, among others. The method further includes detecting an aberrant combustion event from the combustion of the injected fuel. If an aberrant combustion event is detected, the electrical current waveform associated with the injection event may be disabled. Additionally, upon detection of an aberrant combustion event, a value corresponding to the number of detected aberrant combustion events is incremented, which may be used to determine whether or not to continue to disable the selected waveform.

### BACKGROUND

Illustrated embodiments relate to the control of electrical current waveforms used in the operation of a valve of a fuel injector. More specifically, illustrated embodiments relate the control and application of electrical current waveforms used to control the operation of a fuel injector based on the detection of the occurrence of one or more misfires in the cylinder of an internal combustion engine.

In an attempt to comply with increasingly stringent emissions control standards for internal combustion engines, fuel injectors often seek to inject fuel into the combustion chamber of an engine at elevated or amplified pressures. By increasing the pressure of the fuel that is injected into the combustion chamber, both the atomization of the fuel and the mixing of the fuel with oxygen present in the cylinder may improve. As a result, the ability to achieve complete combustion of the fuel may be improved, which may thereby reduce the quantity of particulates formed during the combustion event.

Certain high pressure fuel injectors may include a solenoid that is used to control the operation of a needle control valve, spool valve, and/or poppet valve. The needle control valve may be used to drain or remove fuel that is present above the needle of the needle valve, thereby allowing the pressure of the fuel beneath the needle to lift the needle from a valve seat, and thereby allow fuel to flow out of the fuel injector and into the combustion chamber. Additionally, certain fuel injectors may also include a spool valve that is used to control an intensifier piston that is used to amplify the pressure of the fuel that will be injected into an engine cylinder by the fuel injector. The movement of the needle valve and/or spool valve may be controlled by an electrical current waveform that is sent to the associated solenoid. Moreover, the waveforms may be used to displace the needle valve and/or spool valve between open and closed positions, and vice versa. The characteristics of the waveform may vary according to desired characteristics of the associated injection event. For example, the characteristics of the waveform may indicate, for example, the duration, fuel mass, fuel pressure, and timing of the injection event. Moreover, the waveforms may at least influence when, and how fast, the needle valve and/or spool valve is to be displaced between open and closed positions, and vice versa.

In at least some instances, misfires during combustion events may at least in part be associated with the operation of the fuel injectors and/or the characteristics of the associated fuel injection event. For example, the strength of a combustion event in at least one or more cylinders may be adversely impacted by a variety of different factors, such as, for example, the arrangement of engine components, and the timing that fuel is injected into, and/or combusted in, the cylinder in relation to similar injection and/or combustion events in other cylinders. Moreover, the injection of fuel into one cylinder from a fuel supply source, such as, for example, a common rail, among others, may result in a decrease in fuel pressure in at least a portion of the fuel supply source, which may adversely impact a subsequent fuel injection and/or combustion event in an adjacent cylinder. As a result, the energy or power generated by the combustion of fuel in the cylinder may be reduced, with a relatively significant reduction in generated energy being considered a misfire in the cylinder.

In at least some instances, the waveforms used to control the movement of the needle and/or spool valve may result in the characteristics of the associated injection event causing, or tending to cause, a misfire. For example, the waveform(s) may result in the fuel injector not injecting a sufficient fuel mass into the cylinder. And besides impacting the operation of the engine, such misfiring may result in the detection of failures by the on-board diagnostic (OBD) system, activate check engine lights, and present driver satisfaction issues.

### BRIEF SUMMARY

Certain embodiments of the present technology provide a method for controlling the operation of a valve of a fuel injector, including providing, by a control unit, an electrical current waveform to the valve to control at least one characteristic of an injection of a fuel into a cylinder. The method also includes detecting an aberrant combustion of the fuel injected into the cylinder and disabling the electrical current waveform associated with the occurrence of the detected aberrant combustion for at least a period of time.

Additionally, certain embodiments of the present technology provide a method for controlling the operation of a valve of a fuel injector. The method includes selecting, by a control unit, a first electrical current waveform from a plurality of selectable electrical current waveforms. The first electrical current waveform is provided to the valve, which is operated using the first electrical current waveform to control a characteristic of an injection event. The method further includes detecting an aberrant combustion event from the combustion of fuel from the first injection event and disabling, upon detection of an aberrant combustion event, the use of the first electrical current waveform. Additionally, upon detection of an aberrant combustion event, a value corresponding to the number of detected aberrant combustion events is incremented.

### BRIEF DESCRIPTION OF SEVERAL VIEWS OF THE DRAWINGS

FIG. 1 illustrates an exemplary block diagram of an actuating fluid system.

FIG. 2 illustrates a cross-sectional view of a representative electronically controlled fuel injector.

FIG. 3 illustrates a cross section of a three-way needle control valve of a representative electronically controlled fuel injector.

FIG. 4 illustrates a flow chart of a method for controlling the electrical current waveform used to operate a fuel injector.

### DETAILED DESCRIPTION

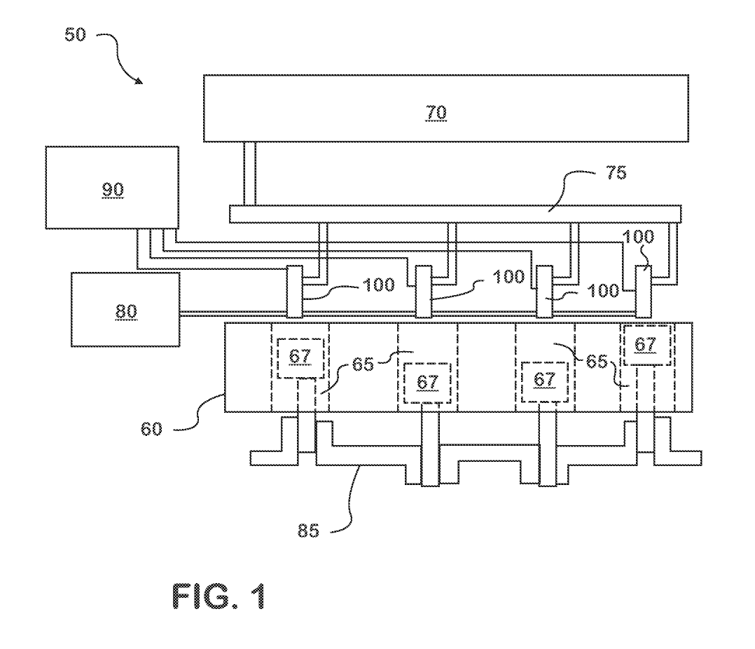

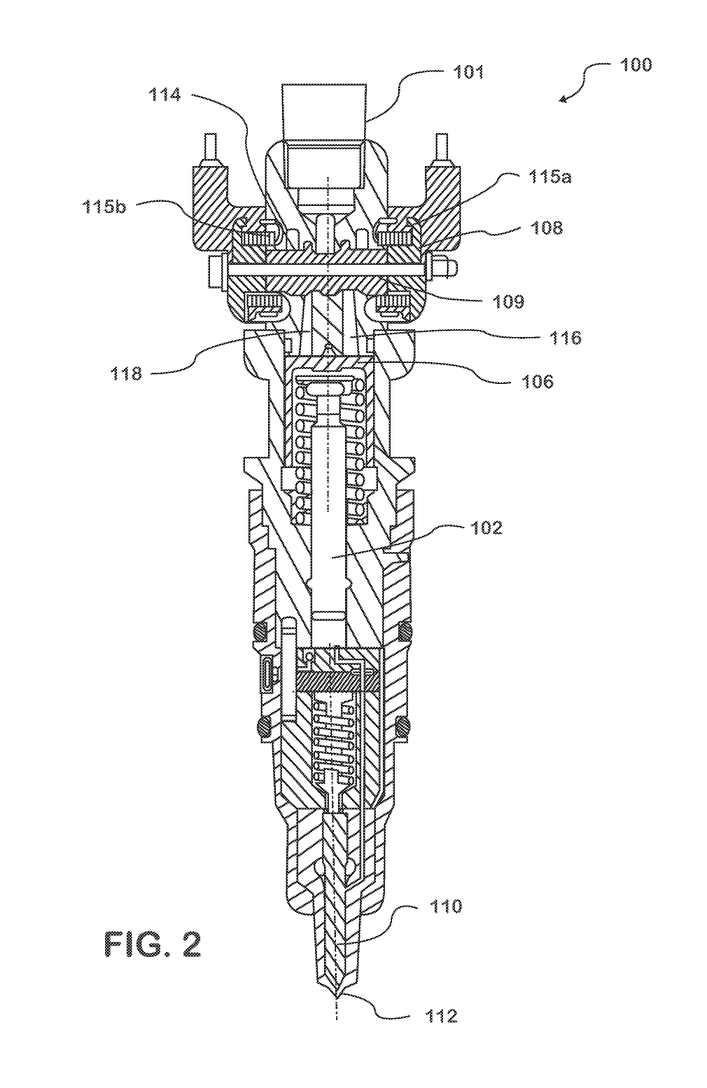

Referencing FIGS. 1 and 2, a fuel injector 100 may be used with an electronically controlled fuel injection system. The fuel injector 100 may include one or more electronically controlled valves that are used to control the injection of fuel into a cylinder 67 of an engine, such as for example, an intensifier control valve that is used to control the amplification of a fuel pressure in the fuel injector, and a needle control valve used to control the positioning of a needle so as to control the release of fuel from the fuel injector 100 into the cylinder 67.

For example, the fuel injector 100 includes an electronically controlled control valve 108 that is used to control the delivery of a high pressure actuating fluid in the fuel injector 100 to an intensifier piston 106. The actuating fluid may be provided from an actuating fluid system 50 that supplies the actuation fluid to a fluid inlet 101 of the injector 100 through a hose, tube, or common rail 75. A volume of the actuating fluid, such as a control volume, may be delivered into a fluid inlet 101 of the fuel injector 100 and to a location that is adjacent to an upper surface of the intensifier piston 106. The control volume of actuating fluid may exert a force on the intensifier piston 106 to displace the intensifier piston 106 and associated plunger 102 into an area of the fuel injector 100 that was previously occupied by fuel while increasing the pressure of fuel in the fuel injector 100.

The supply of actuating fluid for the control volume may be controlled by the control valve 108. For example, according to certain embodiments, the intensifier control valve 108 may be a spool valve that includes at least one spool 109 and at least one coil 115. In the illustrated embodiments, a pair of coils 115a, 115b may be used to control the position of the spool 109 within a chamber 114 in the fuel injector 100.

The chamber 114 may be in fluid communication with the fluid inlet 101 and be configured for reciprocal movement of the spool 109 within the chamber 114. Additionally, the chamber 114 may be in communication with an inlet passageway 116 that is configured for the delivery of actuating fluid to the area adjacent to the intensifier piston 106 so as to be used as the control volume of actuating fluid. Additionally, according to certain embodiments, the chamber 114 may also be in fluid communication with an outlet passageway 118 that is used to evacuate actuating fluid that had been used as a control volume of actuating fluid back into the chamber 114 and subsequently out of the fuel injector 100. Additionally, depending on the injector 100 design, rather than being separate pathways, the inlet and outlet pathways 116, 118 may be the same pathway. At least a portion of the actuating fluid evacuated from the fuel injectors 100 may be subsequently collected in a sump 80 and re-circulated in the system 50.

The position of the spool 109 within the chamber 114 may determine whether actuating fluid may flow into the inlet passageway 116 and/or out of the outlet passageway 118. Moreover, when in the closed position, the spool 109 may cover or otherwise prevent the flow of actuating fluid into the inlet passageway 116. Further, when in an open position, the spool 109 may be positioned to allow actuating fluid to enter into the inlet passageway 116 so that a sufficient quantity and/or pressure of actuating fluid may provide a force to displace the intensifier piston 106.

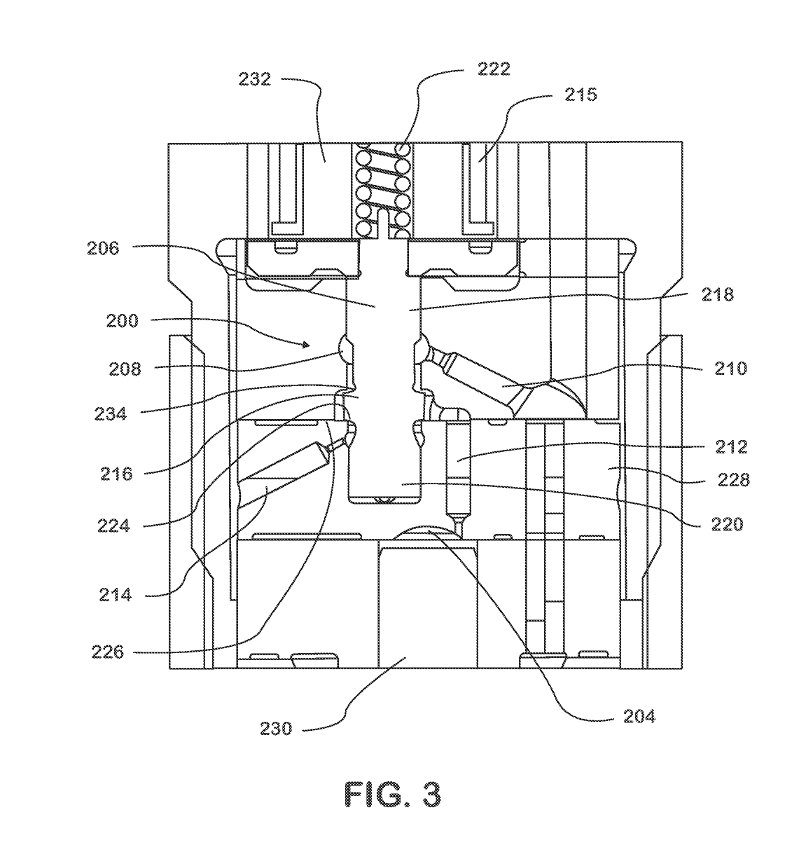

Referencing FIGS. 2 and 3, the position of the intensifier and/or needle control valves 108, 200 may be controlled by the supply, or lack thereof, or electrical current to the valves 108, 200. For example, the flow of electrical current through the metallic coils 115a, 115b of the intensifier control valve 108 may create a magnetic field that is used to attract and/or repel the spool toward or from a coil 115a, 115b. For example, for purposes of illustration, referencing FIG. 2, an electrical current through a first coil 115a, and not a second coil 115b, may attract and/or displace the spool 109 toward the first coil 115a. The spool 109 may then be displaced toward the second coil 115b when an electrical current flows through the second coil 115b, and not the first coil 115a. Such displacement may be used to control the position of the spool 109 within the chamber 114. Moreover, such displacement may be used to control whether the spool 109 is in an open or closed position so as to control the flow of actuating fluid for purposes of displacing the intensifier piston 106 and amplifying injection fuel pressure. Although discussed in terms of a spool valve, the intensifier control valve 108, as well as other valves of the fuel injector 100, may use a variety of different electronically controlled valves, including, for example, poppet valve, among others.

FIG. 3 illustrates a cross section of a three-way needle control valve 200 in another type of fuel injector 100′. The control valve 200 includes a poppet member 206, a valve bore 208, and a first, second, and third fuel pathway 210, 212, 214. The poppet member 206 includes a poppet projection 216 and upper and lower guides 218, 220. When the poppet member 206 is in a closed position, a spring 222 may press a first surface 224 of the poppet projection 216 against an upper surface 226 of a throttle plate 228 so as to create a seal that prevents the flow of fuel into the third fuel passageway 214. Fuel may then flow from the first fuel pathway 210, into the valve bore 208, and through the second fuel pathway 212 to the control chamber 204. Fuel in the control chamber 204 may exert a force on the needle 230 to prevent pressurized fuel in the nozzle chamber from lifting the needle 230 to an open position.

When fuel is to be injected into the combustion chamber, electrical current flows through a coil 215 of a solenoid 232 to draw an armature 234, and the attached poppet member 206, to the solenoid 232, thereby moving the poppet member 206 to an open position. When in the open position, the first surface 224 of the poppet projection 216 is lifted from the upper surface 226 of the throttle plate 228. Pressure differentials may draw the control volume of fuel from the control chamber 204, through the second fuel pathway 212 and the valve bore 208, and into the third pathway 214, where the fuel may then be delivered to a low pressure area.

According to certain embodiments, a control unit 90, such as an electronic control unit or an injector drive module, may control the application of the electric current being delivered to control the intensifier and needle control valves 108, 200, of the fuel injector 100. For example, the control unit 90 may send an electric current having a particular waveform across the coils 115a, 115b of the intensifier control valve 108 and/or of the solenoid 232 of needle control valve 200. The size and/or duration of the current applied to the valves 108, 200 may depend on the operating conditions of the engine. Moreover, the characteristics of the electrical current waveform applied to the valves 108, 200 used to open and/or close the valves 108, 200, such as for example, changing the position of the spool 109 may be driven by different, real-time characteristics of the engine's operation, including, for example, rail pressure, fuel pressure, operation modes, measurements during engine operation, and/or associated data provided by an operational map. For example, the control unit 90 may include or have access to an operation map that indicates the fuel mass (mg/stroke) of the fuel needed, or will be, to injected by the fuel injector 100 into the cylinder or combustion chamber 65 when the engine is operating at a particular torque and revolutions per minute (RPMs). For example, the operational map may indicate that for 700 RPMs of the crankshaft 85 and 140 ft-lb, the fuel injector will be injecting 14 mg of fuel into the cylinder 65 per engine stroke (mg/stk). The operational map may however contain a variety of other, different types of operational data. The injected fuel may be combusted in the cylinder 65 during a combustion event, which may, at least in part, cause the displacement of a piston 67 in a cylinder 65, which may thereby may be translated into rotational movement of a crankshaft 85.

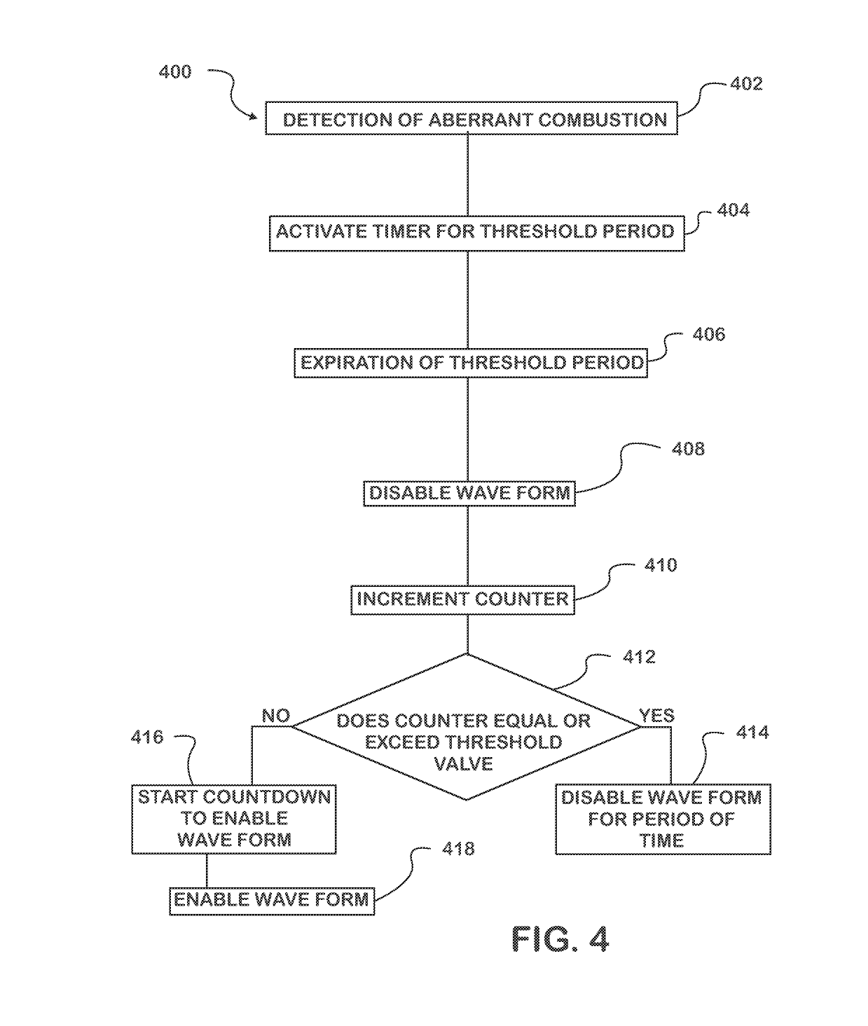

FIG. 4 illustrates a flow chart for a method 400 of controlling the electrical current waveform used to operate a fuel injector. At step 402, an aberrant combustion event is detected, such as, for example, a misfire or a combustion event that is either above or below power requirements or other operating parameters for the combustion event. Such an aberrant combustion event may be detected in a number of different manners. For example, according to certain embodiments, the aberrant combustion event may be detected by the angular velocity of the crankshaft 32 and/or changes in the angular velocity of the crankshaft 32. Such detection of the angular velocity of the crankshaft 32, which may employ a speed sensor, may be determined relative to one or more cylinders 65 not attaining a desired speed. Moreover, the speed of the crankshaft 32 may allow for a determination of speed value for each piston 67. A comparison of the speeds of the pistons 67 may indicate whether an aberrant combustion event occurred in the particular cylinder 65 associated with the piston 65. An aberrant combustion event may also be detected, for example, by the degree of heat released in the cylinder 65 relating to a combustion event, the pressure change in the cylinder 18 relating to a combustion event not attaining a desired level, and/or the piston(s) 67 not traveling a predetermined distance within a specified time.

If an aberrant combustion event has been detected at step 402, then at step 404 a timer may be activated for a threshold period. For example, according to certain embodiments, the timer may be activated for a period of time, the number of injection events, a distance of vehicle travel, number of revolutions of the engine crankshaft, the number of piston strokes, or the position or movement of the piston, among other thresholds. According to certain embodiments, at step 404 a timer may be activated. The timer may be part of, or operably connected to, the control unit 90. According to certain embodiments, the timer may be employed to determine the duration during which consecutive or non-consecutive aberrant combustion events are occurring. Additionally, according to certain embodiments, the timer may be activated when an aberrant combustion event is, or is not, detected at step 402, such that the timer is used to determine the duration of time between aberrant combustion events.

After the satisfaction or expiration of the threshold period at step 406, then at step 408, the waveform(s) that had been used to control the operation of one or more of an electronically controlled valve of the injector 100, when the aberrant combustion event occurred may be disabled. Accordingly, the control unit 90 may determine which waveform(s) were in use when the associated combustion event occurred. Additionally, according to certain types of injectors 100, 100′, different waveforms may be employed for different valves of the injector, such as, for example, the intensifier and/or needle control valve 108, 200. Therefore, the control unit 90 may attempt to determine the waveform that was being used with a particular valve 108, 200, and/or the waveforms that were used by more than one valves 108, 200 when the associated aberrant combustion event occurred. Additionally, according to certain embodiments, based on the detected characteristics of the aberrant combustion event, the control unit 90 may attempt to determine which valve 108, 200 contributed to the characteristics of the injection event that may have led to the occurrence of the aberrant combustion event, and therefore, which waveform to deactivate.

According to certain embodiments, disabling of the waveform associated with the occurrence of the aberrant combustion event may occur each time an aberrant combustion event is detected. However, according to other embodiments, such disabling of the waveform may not occur until a threshold variable, such as, for example, a number of aberrant combustion events have consecutively occurred, occurred within a particular time period, or the ratio of aberrant combustion events to acceptable or normal combustion events for the cylinder(s) attains or exceeds a particular ratio. Further, according to certain embodiments, the disabling of a waveform will result in the selection of a default waveform for controlling the operation of the spool 109. However, according to other embodiments, the disabling of a waveform merely reduces the number of waveforms that may be selected to control the operation of spool 109.

According to certain embodiments, at step 410 an incremented variable or counter may be incremented based on the number of times a certain waveform is disabled. Moreover, the counter may track the number of aberrant combustion events, the number of acceptable or normal combustion events, or a combination thereof. According to certain embodiments, the counter, which may be part of or connected to the control unit 90, may be incremented, such as by “1.” According to certain embodiments, the counter may be incremented in response to each occurrence of an aberrant combustion event, the occurrence of an aberrant combustion event during a certain time period, the number of times a certain waveform has been disabled, and/or whether the detected aberrant combustion event was preceded by a misfire. Additionally, according to certain embodiments, the counter may be reset upon the occurrence of certain events. For example, the counter may be reset after the occurrence of one or more combustion event(s) that is/are not determined to be an aberrant combustion event, after a period of time, or after engine or associated vehicle operating conditions change.

The types or shapes of waveforms used to operate the spool 109 may change over time and/or different waveforms may be used during the operation of the engine. Therefore, according to certain embodiments, the tracking of aberrant and/or acceptable combustion events may include associating the waveform used when the aberrant combustion event or non-aberrant combustion event occurred. Such an embodiment may allow for a more precise identification of the waveform shape or type of waveform that is, or has a higher, propensity for being related to the occurrence of an aberrant combustion event.

At step 412, the control unit 90 may determine whether the counter has been incremented to a value that equals or exceeds a threshold value. For example, the control unit 90 may determine whether the counter has been incremented such that the number of aberrant combustion events that have been tracked by the counter equals or exceeds a threshold number of aberrant combustion events.

If the control unit 90 determines that the counter has been incremented to a value that exceeds a threshold value, then at step 414 if the waveform that had been used to control the operation of the spool 109 when the aberrant combustion event occurred is not already disabled, the control unit 90 may disable the waveform. Additionally, regardless or previously disabled or currently being disabled, at step 412 the duration that the waveform will be disabled may be established. The duration for which the waveform will be disabled may be based on a variety of different factors. For example, according to certain embodiments, the waveform may be disabled until the engine is put into a key-off condition, such as, for example, when a user reaches a destination and ceases operation of the vehicle and associated engine prior to exiting the vehicle. According to other embodiments, the waveform may be disabled for a set period of time. Alternatively, the waveform may be permanently disabled, or may be disabled until the engine undergoes a maintenance or service operation.

However, if the control unit 90 determines that the counter has not been incremented to a value that exceeds a threshold value, then at step 416, the method 400 may determine when the previously deactivated waveform may be reactivated or enabled for use. For example, according to certain embodiments, at step 416, a timer may be activated to start a countdown as to when the deactivated waveform may again be used to control a valve of the fuel injector, such as, for example, the intensifier and/or needle control valves 108, 200. The timer may be the same or different than the timer mentioned at step 404. The timer may employ a variety of different ways of tracking the period during which misfires are, or are not, occurring.

For example, according to certain embodiments, the timer may be timed based, such that after a specific time period, the deactivated waveform may be reactivated. However, according to other embodiments, the re-activation of the deactivated waveform may be based on the occurrence of certain events, such as, for example, the occurrence of a threshold number of injection events and/or combustion events, among other events. At step 418, upon the criteria for step 416 being satisfied, such as the completion of a countdown by the timer, the deactivated waveform may be reactivated, and thus used again, to control the operation of the associated valve 108, 200. As the method 400 may be employed for each injection event in a cylinder 65 for any or all of the cylinders 65 of the engine, the method 400 may continuously be performed, thereby allowing for continuous checking of misfires and re-checking of misfires related to reactivated waveforms.

1. A method for controlling the operation of a valve of a fuel injector, the method comprising:
providing, by a control unit, an electrical current waveform to the valve to control at least one characteristic of an injection of a fuel into a cylinder;
detecting an aberrant combustion of the fuel injected into the cylinder; and
disabling the electrical current waveform associated with the occurrence of the detected aberrant combustion for at least a period of time.

2. The method of claim 1, further including the step of incrementing a counter after the detection of the aberrant combustion of the fuel.

3. The method of claim 2, further including the step of determining whether an incremented variable meets or exceeds a threshold value.

4. The method of claim 3, further including the step of re-activating the electrical current waveform if the incremented value is determined to not meet or exceed the threshold value.

5. The method of claim 4, further including the step of continuing to disable the electrical current waveform, if the incremented value is determined to meet or exceed the threshold value, until a threshold condition is satisfied.

6. The method of claim 1, wherein the valve is either an intensifier control valve or a needle control valve.

7. The method of claim 6, wherein the aberrant combustion is a misfire.

8. The method of claim 7, wherein the detection of the aberrant combustion includes sensing a speed of a crankshaft.

9. The method of claim 6, wherein the aberrant combustion is the power of the combustion event being above or below a desired range or value.

10. A method for controlling the operation of a valve of a fuel injector, the method comprising:
selecting, by a control unit, from a plurality of selectable electrical current waveforms a first electrical current waveform;
providing the first electrical current waveform to the valve;
operating the valve using the first electrical current waveform to control a characteristic of an injection event;
detecting an aberrant combustion event from the combustion of fuel from the first injection event;
disabling, after detection of an aberrant combustion event, the use of the first electrical current waveform; and
incrementing, upon detection of an aberrant combustion event, an incremented variable corresponding to the number of detected aberrant combustion events.

11. The method of claim 10, wherein the valve is an intensifier control valve and/or a needle control valve.

12. The method of claim 11, further including the steps of:
determining whether the incremented value meets or exceeds a threshold value;
re-activating the first electrical current waveform if the incremented value is determined to not meet or exceed the threshold value; and
continuing to disable the electrical current waveform, if the incremented value is determined to meet or exceed the threshold value, until a threshold condition is satisfied.

13. The method of claim 12, further including the step of resetting the threshold value upon satisfaction of the threshold condition.

14. The method of claim 10, further including the step of selecting, by a control unit, from the plurality of electrical current waveforms a second electrical current waveform, wherein the plurality of selectable waveforms do not include the disabled first electrical current waveform.

15. The method of claim 14, further including the steps of, after detection of the aberrant combustion, activating a timer for a threshold period, and wherein the step of disabling the first electrical current waveform occurs upon satisfaction or expiration of the threshold period.
